(19) United States
(12) Patent Application Publication
(10) Pub. No.: US 2002/0108673 A1
(43) Pub. Date: Aug. 15, 2002

(54) Trickling safeguard

(75) Inventor: Gunther Hecht, Pfaffenhofen (DE)

Correspondence Address: NIXON PEABODY, LLP, 8180 GREENSBORO DRIVE, SUITE 800, MCLEAN, VA, 22102, US

(73) Assignee: Hecht Anlagenbau Gmbh, Pfaffenhofen/Ilm (DE)

(21) Appl. No.: 10/074,036

(22) Filed: Feb. 14, 2002

(30) Foreign Application Priority Data
Feb. 15, 2001 (DE) 101 07 172.8

(51) Int. Cl. B65B 3/04; B67C 3/02; B65B 1/04

(52) U.S. Cl. 141/97

(57) ABSTRACT

Trickling safeguard for a filling station used to fill containers with bulk material, the filling station having a fill tube through which the bulk material flows into the container. The safeguard includes a two-part flap whose dimensions at least match those of the interior cross section of the fill tube and is arranged transverse to the length of the fill tube at the end thereof. The flap parts are pivotable about a shaft so as to lie in the direction of the bulk material stream.

### BACKGROUND OF THE INVENTION

1. Field of the Invention

The invention relates to a trickling safeguard for a filling station used to fill containers with bulk material, which includes a fill tube through which the bulk material gets into the container.

2. Description of the Related Art

Containers, such as sacks, bags, drums or the like, are usually filled with a bulk material in a filling station conceived specifically for this purpose. In this regard, the filling station has a fill tube, through which the bulk material gets into the container.

When changing a container, during which a container is briefly unconnected to the fill nozzle of the fill tube, portions of the bulk material, e.g., those which adhere to the interior wall of the fill tube, can trickle out of the fill tube and spill into the environment, e.g., the floor of the room housing the fill station.

In order to prevent this from happening, shut-off devices are usually provided, the shut-off devices serving to seal the fill tube when changing a container to prevent the bulk material from trickling. However, conventional shut-off devices are designed in such a way that, when opened, i.e., while filling a container, they come into contact with the stream of bulk material, so that parts of the shut-off devices also become contaminated with bulk material even on the surfaces that face to the outside in the closed state. Therefore, pieces of bulk material can still trickle from these surfaces and get into the environment, so that a completely clean seal to the outside cannot be achieved with conventional shut-off devices.

### SUMMARY OF THE INVENTION

Accordingly, a primary object of the invention is to provide a trickling safeguard for a filling station that enables a clean seal of the fill tube to the outside when changing a container.

This object, as well as other objects, is achieved in accordance with the invention by providing a trickling safeguard including a two-part flap whose dimensions at least match those of the interior cross section of the fill tube, the flap being arranged transversely in the fill tube. The flap parts are adapted to collapse around a shaft so as to be placed in the direction of the bulk material stream.

The trickling safeguard in accordance with the invention is preferably arranged at the lower end of the fill tube, and the flap parts are collapsed during the filling process and flipped open prior to removing the filled container from the fill tube, so that the fill tube is sealed to the outside. Since the surfaces of the flaps which face towards the outside when closed are the ones against which the flap parts abut in the collapsed state in the open state during the filling process, so that they do not become contaminated, any contamination by bulk material portions adhering to these surfaces is precluded. This achieves a completely clean seal relative to the environment, which ensures optimal personal protection while filling bulk material, at levels below the maximum workplace contamination limits (MAK) as prescribed by law.

The accompanying drawings will be used below to describe particularly preferred embodiments of the trickling safeguard according to the invention.

### BRIEF DESCRIPTION OF THE DRAWINGS

FIG. 1 is a perspective view of a typical fill station to fill containers with a bulk material;

FIG. 2 is a perspective view of the basic structure of a trickling safeguard in accordance with the invention in a closed state;

FIG. 3 is a partially cut perspective view of the device shown on FIG. 2 in the closed state;

FIG. 4 is a partially cut perspective view of the device shown on FIG. 2 in the open state;

FIG. 5 is a perspective view of a first embodiment of the driving unit for the trickling safeguard in accordance with the invention;

FIG. 6 is a perspective view of the driving unit of FIG. 5 in detail;

FIG. 7 is a sectional view of the driver unit shown on FIG. 6;

FIG. 8 is a perspective view of another embodiment of the driving unit for the trickling safeguard in accordance with the invention;

FIG. 9 is the driving unit shown on FIG. 8 in detail;

FIG. 10 is a perspective view of a modification of the driving unit shown on FIG. 8; and

FIG. 11 is a perspective view showing another driving unit for the trickling unit in accordance with the invention in.

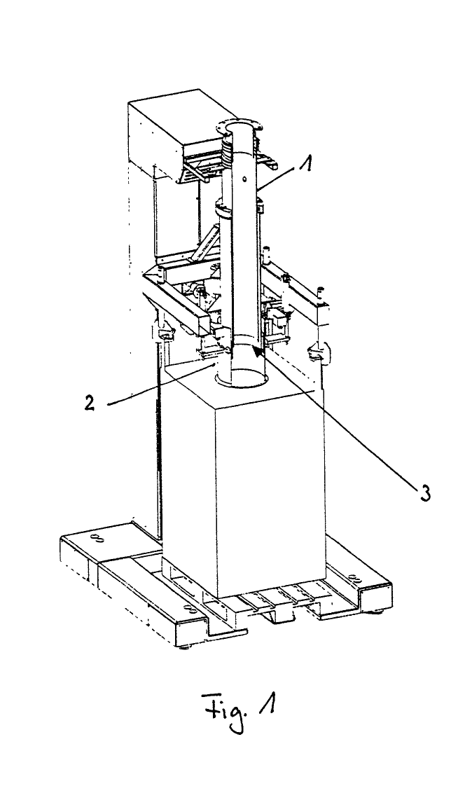

The fill station shown on FIG. 1 exhibits a fill tube 1, through which a bulk material gets into a container 2, e.g., a bag or sack.

### DETAILED DESCRIPTION OF THE INVENTION

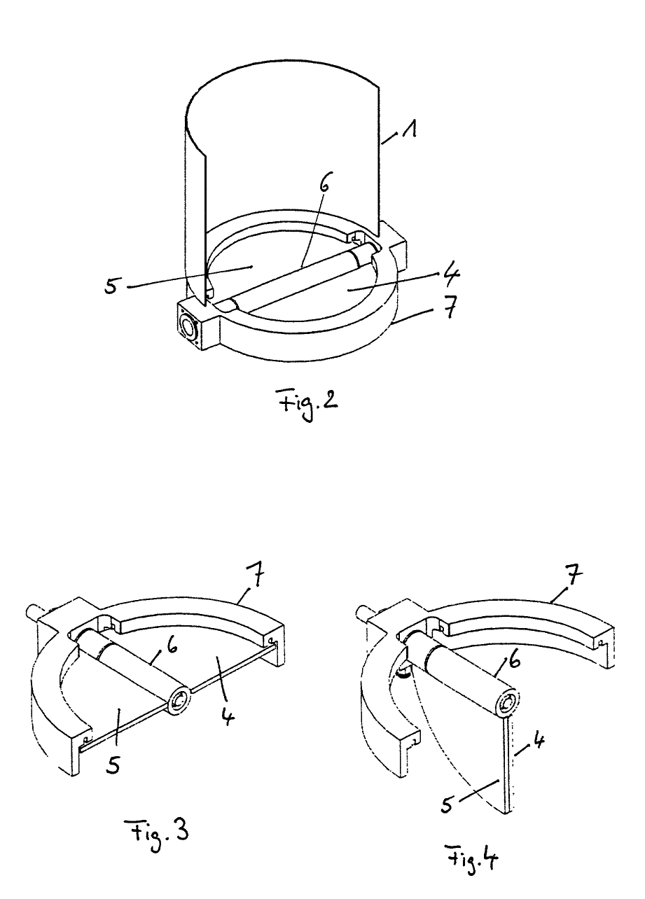

As shown in FIG. 1, in order to prevent bulk material from trickling while changing a container, during which a container is briefly not connected to the fill nozzle of the fill tube, a trickling safeguard is preferably provided at the lower end 3 of the fill tube 1, which can seal the fill tube 1 to the outside during the change of containers. The trickling safeguard includes a two-part flap with flap parts 4, 5, which are attached to a shaft 6 sitting in an annular mount 7 mounted at the lower end of the fill tube 1, or directly fixed to the fill tube 1 or fitted inside the fill tube 1. The dimensions or outer periphery of the two-part flap correspond at least to the interior cross section or periphery of the fill tube 1, so that in the closed state shown on FIG. 2 and FIG. 3, it can completely seal the interior of the fill tube 1 to the outside.

The flap parts 4, 5 of the two-part flap are pivotable around the shaft 6, and can be collapsed into the position shown on FIG. 4, i.e., in the direction of the bulk material stream, and hence down in the filling station shown on FIG. 1. As shown in detail on FIG. 4, the outside surfaces of both flap parts 4, 5 lie against, i.e., abut each other in the collapsed state.

The trickling safeguard described above works as follows. If a container 2 is connected to the fill nozzle of the fill tube 1 and is to be filled or is being filled, the trickling safeguard is opened, i.e., arranged with its flap parts 4, 5 in the collapsed state shown in FIG. 4. If the container is filled, only the surfaces of flap parts 4, 5 come into contact with the bulk material, which face to the inside of the fill tube in the closed state as shown in FIG. 3. The surfaces of flaps 4, 5 which face outside in the closed state, do not come into contact with the bulk material while filling.

Shortly before a filled container is removed from the fill tube 1, the trickling safeguard is closed, i.e., the flap parts 4, 5 are pivoted around the shaft 6 into a position transverse to the fill tube 1, which is shown on FIG. 3. In this state, the fill tube 1 is completely sealed to the outside, so that no bulk material can trickle in, which holds true in particular when the trickling safeguard is arranged on the outermost end of the fill tube. The surfaces of the flaps 4, 5 facing outside in the closed state are clean, since they do not come into contact with bulk material during the filling process. After changing the container, when a new container has been connected to the fill tube, the trickling safeguard is opened again, so that the new container can be filled.

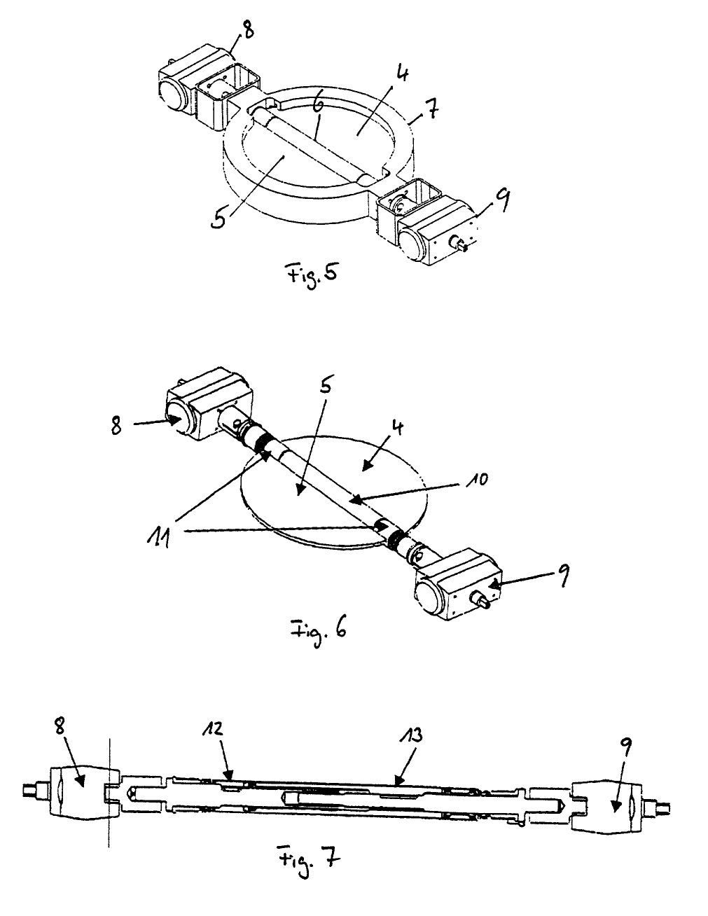

FIGS. 5-11 show embodiments of the invention including driving units for pivoting the flap parts 4, 5 of the trickling safeguard open and closed. In the embodiment shown in FIGS. 5-7, a pivoting actuator, in particular a double-piston swiveling actuator 8, 9, is provided for each flap part 4, 5 to pivot the flap parts 4, 5 about the shaft 6.

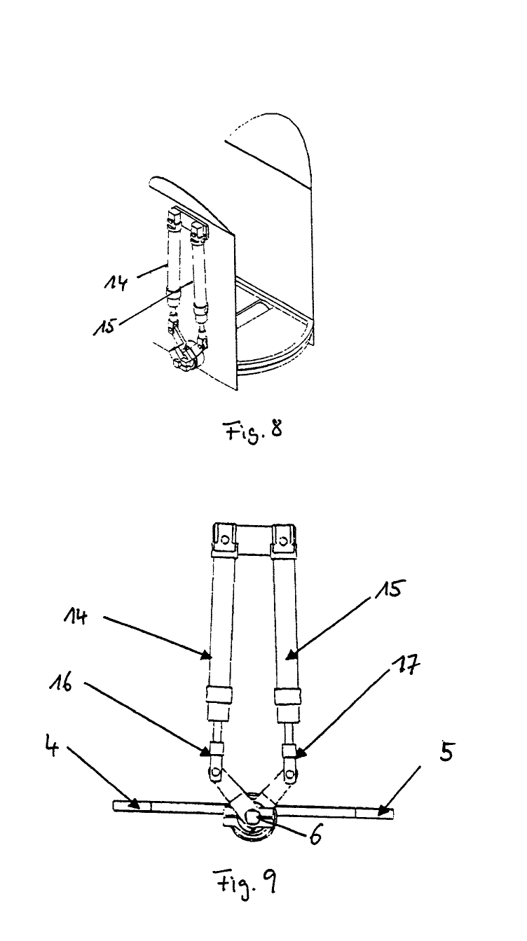

As shown on FIGS. 6 and 7, the shaft includes three individual parts, including two outer parts 11 connected to one flap part 5 and an inner shaft part 10 connected to the other flap part 4. As shown in FIG. 7, the actuators 8, 9 are each linked at catching points 12, 13 with the outer shaft parts 11 and the inner shaft part 10. The shaft 6 can also be designed in two segments, wherein each flap part 4, 5 is connected with a shaft segment. When the actuator 8 is operating, it turns the outer shaft segments 11, thereby catching the flap part 5, while the actuator 9 turns the inner shaft segment 10, thereby catching the flap segment 4. The catching points 12, 13 for the outer 11 and inner 10 shaft segments are preferably designed as grooves to which the actuators 8, 9 are coupled, as shown in detail in FIG. 7.

FIGS. 8-10 show an embodiment of the driving unit that lies inside the fill tube, in contrast to the design described above. In this embodiment, two pneumatic or hydraulic cylinders 14, 15 are provided, which pivot the flap parts 4, 5 around the shaft 6 via levers 16, 17. The cylinders 14, 15 can be built into the fill tube on one or both sides.

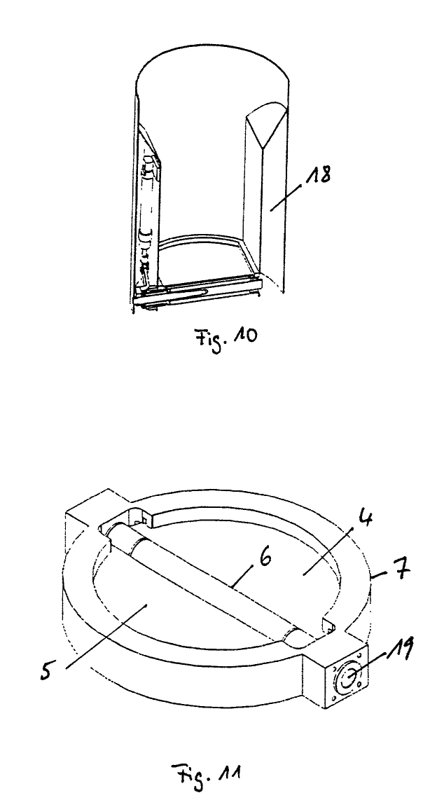

As shown in on FIG. 9, upon activation of the cylinders 14, 15, the levers 16, 17 move toward the flap parts 4, 5, i.e., toward the bottom in the fill station shown on FIG. 1, so that each lever 16, 17 turns a segment of the shaft 6, namely the inner segment 10 or the outer segments 11, and pivots the flap part 4, 5 linked thereto. In the embodiment shown in FIG. 8, the trickling safeguard can be arranged in particular at the lowermost end of the fill tube, without it colliding with parts secured on the outside of the fill tube.

As shown in FIG. 10, in driving units lying on the inside, a segment 18 of the fill tube is separated from the stream of bulk material, and the driving units are provided in segment 18. Instead of cylinders 14, 15 in the embodiment described above, use can also be made of Bowden cables, so that the driving unit can be situated at any point outside the fill tube.

Finally, FIG. 11 shows a third embodiment of the driving unit for the trickling safeguard, which does not employ outside driving components. In this embodiment, the driving unit is housed in the shaft 6, and designed as a pneumatic rotary actuator. For this purpose, the shaft 6 is conceived as a hollow shaft with various chambers that are actuated pneumatically or hydraulically via terminals 19.

What is claimed is:

1. A trickling safeguard for a filling station that fills containers with bulk material, the filling station having a fill tube through which the bulk material flows into a container, the trickling safeguard comprising:
a flap mechanism adapted for mounting transverse with respect to the length of the fill tube, said flap mechanism including a shaft, a first flap and a second flap, each flap being pivotably connected to said shaft for movement between a closed position in which a seal is formed between said flap mechanism and the fill tube preventing bulk material from flowing from the fill tube into a container, and an open position permitting the flow of the bulk material from the fill tube into the container, movement toward said open position being in a direction of flow of the bulk material through the trickling safeguard and surfaces of said flaps which face outwardly away from said fill tube in said closed position being brought together in said open position.

2. The trickling safeguard according to claim 1, wherein said flap mechanism is mounted at a distal end of the fill tube.

3. The trickling safeguard according to claim 1, wherein said shaft comprises a plurality of segments, each of said first flap and said second flap being pivotably attached to a respective shaft segment.

4. The trickling safeguard according to claim 2, wherein said shaft comprises a plurality of segments, each of said first flap and said second flap being pivotably attached to a respective shaft segment.

5. The trickling safeguard according to claim 3, wherein said shaft comprises at least two segments.

6. The trickling safeguard according to claim 4, wherein said shaft comprises at least two segments.

7. The trickling safeguard according to claim 1, further comprising a pair of actuators for pivotably driving said first flap and said second flap, respectively, said actuators being mounted at an outer periphery of the fill tube.

8. The trickling safeguard according to claim 1, further comprising a pair of actuators for pivotably driving said first flap and said second flap, respectively, said actuators including a hydraulic cylinder-lever arrangement mounted at an inner periphery of the fill tube.

9. The trickling device according to claim 1, further comprising a pair of actuators for pivotably driving said first flap and said second flap, respectively, said actuators including a pair of levers mounted on an inner periphery of the fill tube and connected to said shaft, and Bowden cables for driving said levers, said Bowden cables being mounted at an area outside of the fill tube.

10. The trickling safeguard according to claim 1, wherein said shaft comprises a hollow shaft having a plurality of chambers adapted for housing a pair of hydraulic actuators for pivotably driving said first flap and said second flap, respectively.
